(19) United States
(12) Patent Application Publication
(10) Pub. No.: US 2013/0169924 A1
(43) Pub. Date: Jul. 4, 2013

(54) APPARATUS AND SYSTEM FOR DATA STORAGE AND RETRIEVAL

(71) Applicants: Hayward LAMPLEY, JR., Alexandria, VA (US); Jantsen Beasley, Waldorf, MD (US)

(72) Inventors: Hayward LAMPLEY, JR., Alexandria, VA (US); Jantsen Beasley, Waldorf, MD (US)

(21) Appl. No.: 13/343,123

(22) Filed: Jan. 4, 2012

(51) Int. Cl. G02C 11/00

(52) U.S. Cl. 351/158

(57) ABSTRACT

According to at least one exemplary embodiment, an apparatus and system for data storage and retrieval may be disclosed. The system and apparatus may include a microchip may be embedded in a pair of eyewear. The apparatus may further include an eyewear frame having at least a bridge and temples, a chip embedded in at least one of said temples, said chip having a first substrate and a second substrate, wherein the first and second substrate are coupled together around the edges of the second substrate and form an interior pocket; an RFID chip integrally formed within said interior pocket; a unique identifier; and a microprocessor

### BACKGROUND

Microchip technology has seen great advancements in recent years. Microchips are now frequently implanted in both wild and domestic animals for tracking and locating purposes. Further, there has been widespread experimentation with human implants for security and medical purposes. Microchips can, and have, been used to link the holder to information stored in an external database relating to security, medical records, location, or some combination thereof. However, the medical risks associated with human microchip implants have created negative perceptions of this technology.

### SUMMARY

According to at least one exemplary embodiment, an apparatus and system for data storage and retrieval may be disclosed. The system and apparatus may include a microchip may be embedded in a pair of eyewear. The apparatus may further include an eyewear frame having at least a bridge and temples, a chip embedded in at least one of said temples, said chip having a first substrate and a second substrate, wherein the first and second substrate are coupled together around the edges of the second substrate and form an interior pocket; an RFID chip integrally formed within said interior pocket; a unique identifier; and a microprocessor

In another exemplary embodiment, a system of data retrieval and storage may be described. This system can include a chip, wherein the chip is embedded in a pair of eyewear and has a particular identifier associated with it; and data, wherein the data may be accessed by the chip.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 is a diagram of an exemplary computer system.

FIG. 2 is an orthogonal view of an exemplary self prescribed chip;

FIG. 3 is an orthogonal view of an exemplary pair of eyewear including a chip.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

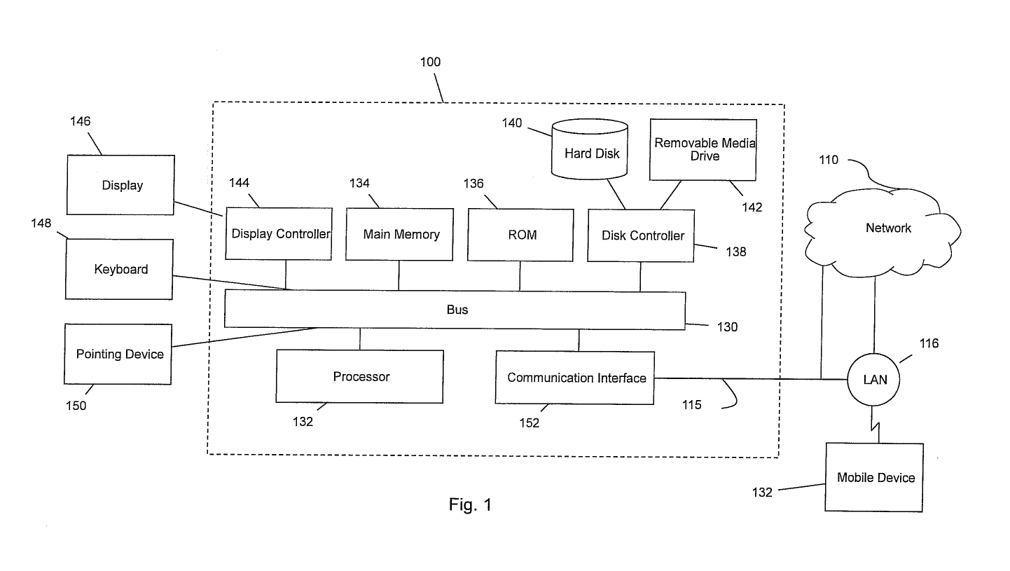

Generally referring to FIGS. 1-3, a an apparatus and system for data storage and retrieval may be disclosed. The apparatus and system may include a scannable, embedded microprocessor configured to be scanned for the placement and retrieval of data. The apparatus may further include a chip, such as an authentication chip, which may include a unique identification number associated with a particular user. The chip may be or may include a microchip, which may include RFID and GPS technology such that the chip may provide a receiver with a variety of information pertaining to the unique identification number. For example, the device may include a unique identification tag, such that when the identification tag is recognized, any data relating to the unique identification tag may be retrieved from an external server through any desired RFID information retrieval methods known in the arts. The chip may have at least a memory ranging from 8- to 32-bit, but in some exemplary embodiments, the memory may be larger.

FIG. 1 illustrates an exemplary computer system 111 upon which an embodiment of the present invention may be implemented. The computer system 111 includes a bus 112 or other communication mechanism for communicating information, and a processor 113 coupled with the bus 112 for processing the information. The computer system 111 also includes a main memory 114, such as a random access memory (RAM) or other dynamic storage device (e.g., dynamic RAM (DRAM), static RAM (SRAM), and synchronous DRAM (SDRAM)), coupled to the bus 112 for storing information and instructions to be executed by processor 113. In addition, the main memory 114 may be used for storing temporary variables or other intermediate information during the execution of instructions by the processor 113. The computer system 111 further includes a read only memory (ROM) 115 or other static storage device (e.g., programmable ROM (PROM), erasable PROM (EPROM), and electrically erasable PROM (EEPROM)) coupled to the bus 112 for storing static information and instructions for the processor 113.

The computer system 111 also includes a disk controller 116 coupled to the bus 112 to control one or more storage devices for storing information and instructions, such as a magnetic hard disk 117, and a removable media drive 118 (e.g., floppy disk drive, read-only compact disc drive, read/write compact disc drive, compact disc jukebox, tape drive, and removable magneto-optical drive). The storage devices may be added to the computer system 111 using an appropriate device interface (e.g., small computer system interface (SCSI), integrated device electronics (IDE), enhanced-IDE (E-IDE), direct memory access (DMA), or ultra-DMA).

Further, exemplary embodiments include or incorporate at least one database which may store software, descriptive data, system data, digital images and any other data item required by the other components necessary to effectuate any embodiment of the present system known to one having ordinary skill in the art. The database may be provided, for example, as a database management system (DBMS), a relational database management system (e.g., DB2, ACCESS, etc.), an object-oriented database management system (ODBMS), a file system or another conventional database package as a few non-limiting examples. The database can be accessed via a Structure Query Language (SQL) or other tools known to one having skill in the art.

Still referring to FIG. 1, the computer system 111 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 111 may also include a display controller 119 coupled to bus 112 to control a display 120, such as a cathode ray tube (CRT), liquid crystal display (LCD) or any other type of display, for displaying information to a computer client. The computer system includes input devices, such as a keyboard 121 and a pointing device 122, for interacting with a computer client and providing information to the processor 113. Additionally, a touch screen could be employed in conjunction with display 120. The pointing device 122, for example, may be a mouse, a trackball, or a pointing stick for communicating direction information and command selections to the processor 113 and for controlling cursor movement on the display 120. In addition, a printer may provide printed listings of data stored and/or generated by the computer system 111.

The computer system 111 performs a portion or all of the processing steps of the invention in response to the processor 113 executing one or more sequences of one or more instructions contained in a memory, such as the main memory 114. Such instructions may be read into the main memory 114 from another computer readable medium, such as a hard disk 117 or a removable media drive 118. One or more processors in a multi-processing arrangement may also be employed to execute the sequences of instructions contained in main memory 114. In alternative embodiments, hard-wired circuitry may be used in place of or in combination with software instructions. Thus, embodiments are not limited to any specific combination of hardware circuitry and software.

As stated above, the computer system 111 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 111, for driving a device or devices for implementing the invention, and for enabling the computer system 111 to interact with a human client. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 113 for execution. A computer readable medium may take many forms, including but not limited to, non-volatile media, volatile media, and transmission media. Non-volatile media includes, for example, optical, magnetic disks, and magneto-optical disks, such as the hard disk 117 or the removable media drive 118. Volatile media includes dynamic memory, such as the main memory 114. Transmission media includes coaxial cables, copper wire and fiber optics, including the wires that make up the bus 112. Transmission media also may also take the form of acoustic or light waves, such as those generated during radio wave and infrared data communications.

Various forms of computer readable media may be involved in carrying out one or more sequences of one or more instructions to processor 113 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 111 may receive the data on the telephone line and use an infrared transmitter to convert the data to an infrared signal. An infrared detector coupled to the bus 112 can receive the data carried in the infrared signal and place the data on the bus 112. The bus 112 carries the data to the main memory 114, from which the processor 113 retrieves and executes the instructions. The instructions received by the main memory 114 may optionally be stored on storage device 117 or 118 either before or after execution by processor 113.

The computer system 111 also includes a communication interface 123 coupled to the bus 112. The communication interface 123 provides a two-way data communication coupling to a network link 124 that is connected to, for example, a local area network (LAN) 125, or to another communications network 126 such as the Internet. For example, the communication interface 123 may be a network interface card to attach to any packet switched LAN. As another example, the communication interface 123 may be a wireless link. In any such implementation, the communication interface 123 sends and receives electrical, electromagnetic or optical signals that carry digital data streams representing various types of information.

The network link 124 typically provides data communication through one or more networks to other data devices. For example, the network link 124 may provide a connection to another computer or remotely located presentation device through a local network 125 (e.g., an 802.11-compliant wireless network) or through equipment operated by a service provider, which provides communication services through a communications network 126. In preferred embodiments, the local network 124 and the communications network 126 preferably use electrical, electromagnetic, or optical signals that carry digital data streams. The signals through the various networks and the signals on the network link 124 and through the communication interface 123, which carry the digital data to and from the computer system 111, are exemplary forms of carrier waves transporting the information. The computer system 111 can transmit and receive data, including program code, through the network(s) 125 and 126, the network link 124 and the communication interface 123. Moreover, the network link 124 may provide a connection through a LAN 125 to a mobile device 127 such as a personal digital assistant (PDA) laptop computer, or cellular telephone. The LAN communications network 125 and the communications network 126 both use electrical, electromagnetic or optical signals that carry digital data streams. The signals through the various networks and the signals on the network link 124 and through the communication interface 123, which carry the digital data to and from the system 111, are exemplary forms of carrier waves transporting the information. The processor system 111 can transmit notifications and receive data, including program code, through the network(s), the network link 124 and the communication interface 123.

Other aspects of the invention may include data transmission and Internet-related activities. See Preston Gralla, How the Internet Works, Ziff-Davis Press (1996), which is hereby incorporated by reference into this patent application. Still other aspects of the invention may utilize wireless data transmission.

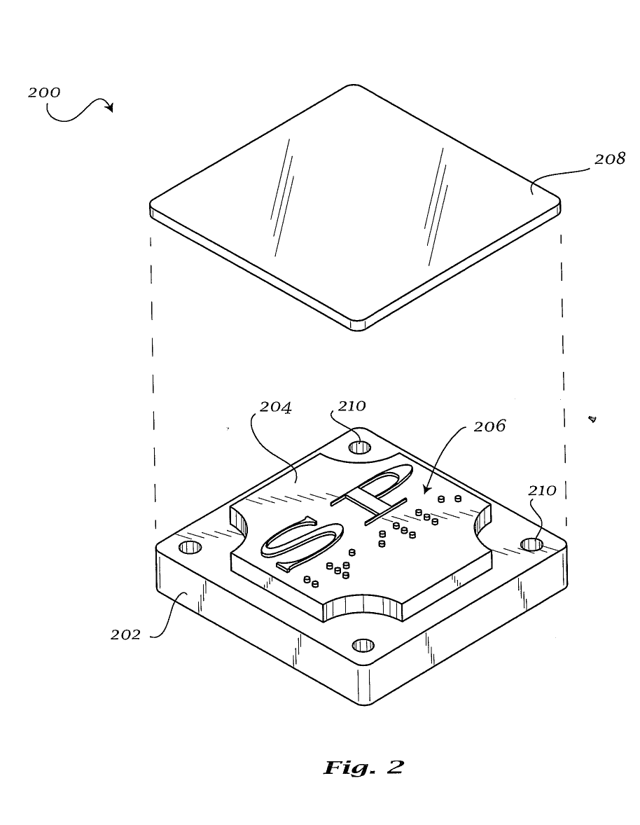

Now referring to FIG. 2, in some exemplary embodiments, the chip may be any desired shape or size. For example, chip 200 shaped in a substantially square fashion, such as a square measuring approximately six millimeters by approximately six millimeters. The chip may be made of any desired material, such as plastic, fiberglass, which may include polycarbonate, acrylonitrile butadiene styrene, or some combination thereof. Chip 200 may include two substrates, a first layer 202 and a second layer 204, where first layer 202 may be in continuous direct contact with the second layer 204. In some exemplary embodiments, the first layer 202 and second layer 204 may be manufactured as one piece. In other exemplary embodiments, first layer 202 and second layer 204 may be manufactured separately and subsequently coupled together in any desired manner.

Still referring to FIG. 2, in some exemplary embodiments, first layer 202 may be a substantially square cuboid. For example, first layer 202 may measure approximately 6.452 millimeters in both length and width and approximately one millimeter in height. Similarly, second layer 204 may also be any desired shape, such as an irregularly shaped octagonal cuboid. Second layer 204 may include eight sides, but four nonconsecutive sides may be concave arcs. Second layer 204 may measure approximately 0.441 millimeters in height, such that layers 202 and 204 may have a total height of 1.441 millimeters. Second layer 204 may also include a brand logo or monogram in any desired location, such as on or in its top surface. The logo, monogram or inscription may be any desired image or lettering, such as “SP” inscribed in bold block face lettering. In other exemplary embodiments, first layer 202 and second layer 204 may be any desired shape of any desired size.

Chip 200 may also include holes 210, which may receive any desired fasteners. Holes 210 may include any desired number of holes, of any desired shape and any desired size, configured in any desired configuration. In some exemplary embodiments, holes 210 may provide openings through which first layer 202 may be fastened to second layer 202. However, in other exemplary embodiments, holes 210 may provide openings through which chip 200, which may include first layer 202 coupled directly to second layer 204, may be coupled to any desired device, garment or other desired object. In some exemplary embodiments, holes 210 may receive one and one-half inch screws which may secure chip 200 to the interior of an eyewear frame.

In some other exemplary embodiments, chip 200 may include circuitry and wiring within or on first layer 202 and second layer 204. For example, first layer 202 and second layer 204 may create a cavity within which circuitry may be installed. Alternatively, circuitry may be installed on first layer 202, second layer 204, or some combination thereof, in accordance with any manner known in the art. For example, first layer 202 may be a printed circuit board which may include conductive pathways and may be capable of receiving electrical components, such as various capacitors and resistors. Chip 200 may include any desired circuitry and any desired electrical components in any desired configuration.

For example, chip 200 may include circuitry configured in any manner known in the art such that chip 200 may serve as an RFID tag. Chip 200 may further include an antenna and other necessary components, such that it may act as either as an active or passive RFID tag, in accordance with methods known in the art. Each chip 200 may also contain a unique identifier 206, such that if an RFID tag interacts with a receiver, a receiver may retrieve unique information associated with the particular identifier 206. Identifier 206 may be read or received by any desired receiver, such that identifier 206 may interact with various receivers employing a wide variety of technologies. For example, identifier 206 may, in some exemplary embodiments, be scanned with bar code scanners as are known in the art. One such receiver may be a key chain barcode scanner which may be provided with any eyewear containing chip 200, such that a user may scan the barcode contained within chip 200 in order to identify the owner, prescription and any other desired information by scanning chip 200.

Identifier 206 may be etched, stamped, stored or otherwise included on chip 200 such that a user may read identifier 206. For example, identifier 206 may be etched onto second layer 204 or, as depicted in the exemplary embodiment of FIG. 2, included in Braille markings. In other exemplary embodiments, identifier 206 may be included as a bar code or any other desired computer readable embodiment. Further, in some exemplary embodiments, identifier 206 may be included in multiple embodiments, such as a Braille engraving and a corresponding bar code, such that identifier 206 may be interact with a wide variety of receiver technologies. Regardless of the manner identifier 206 is included, a user may be able to select or chose their own identifier 206, such that a user may name each particular pair of eyewear containing a chip 200.

Thus, in some exemplary embodiments, a receiver may receive, read or otherwise extract identifier 206 from chip 200 and subsequently receive data or information related to that particular identifier 206. In some exemplary embodiments each unique identifier 206 may be linked to information which may be stored within chip 200 or in an external server or database. Thus, when a receiver receives an identifier 206, it may also receive specific information which is linked to that particular identifier 206 that is stored on chip 200, an external database, or some combination thereof. Such information may relate to any desired information, such as medical history, eyeglasses prescription, biographical information, payment information, or any combination thereof.

If the desired information is associated with chip 200, a user may utilize chip 200 at a payment station, such as a checkout counter in a grocery store, in order to identify him or herself, and pay for an item. This identification may also serve to allow any desired system to determine if a user is a member of a frequent shopper or rewards program. Chip 200 may also provide eyewear style preferences, such as size or color preferences, a shipping address, or any other desired information if it is so requested or desired by the receiving system. In some exemplary embodiments, a user may be able to access any information associated with a particular identifier 206 by accessing the database it is stored within through a personal computer. Thus, a user may enter any data associated with each identifier 206 into the database through a personal computer. Each user may be provided with a personalized website through which to access the database.

In still another exemplary embodiment, chip 200 may include positional tracking and receiving functionality. For example, chip 200 may incorporate or include GPS functionality, in accordance with manners known in the art. In some exemplary embodiments, GPS components may be included on a printed circuit board included in or on either first layer 202 or second layer 204. In other exemplary embodiments, chip 200 may provide for positional tracking through RFID geotagging. For example, if the chip is recognized by a RFID receiver, chip 200 may be determined to be at a certain location, and the location of chip 200 may be tracked trough a series of RFID receivers. Regardless of the manner, chip 200, in some exemplary embodiments, may provide for location determination.

In other exemplary embodiments, chip 200 may allow a user to interact through any desired social networking system. For example, if chip 200 is scanned or received, such as through RFID technology, at a particular terminal, the user's profile on a particular social networking system may be updated to reflect the user's presence in the particular location. In other exemplary embodiments, chip 200 may allow a user to interact in any desired way on any desired social network, such as checking into a certain location on Facebook or Foursquare. Further, in exemplary embodiments which interact with social networking systems, chip 200 may include preprogrammed or predetermined associations with various social networking profiles. Additionally, a user may store or update a phrase of their choosing within chip 200 to be utilized in certain occasions.

Still referring to the exemplary embodiment depicted in FIG. 2, chip 200 may include covering 208. Covering 208 may be constructed from any desired clear coated material, such as fiberglass or plastic, and may be of any desired shape and size. In some exemplary embodiments, and as depicted in FIG. 2, covering 208 may measure approximately six millimeters by six millimeters and have a depth measuring approximately ninety-three hundredths of a millimeter. Covering 208 may, in some exemplary embodiments, seal chip 200 from external elements while simultaneously allowing chip 200 to interact with external devices, such as receivers. For example, covering 208 may be mounted on chip 200 with any desired epoxy coating.

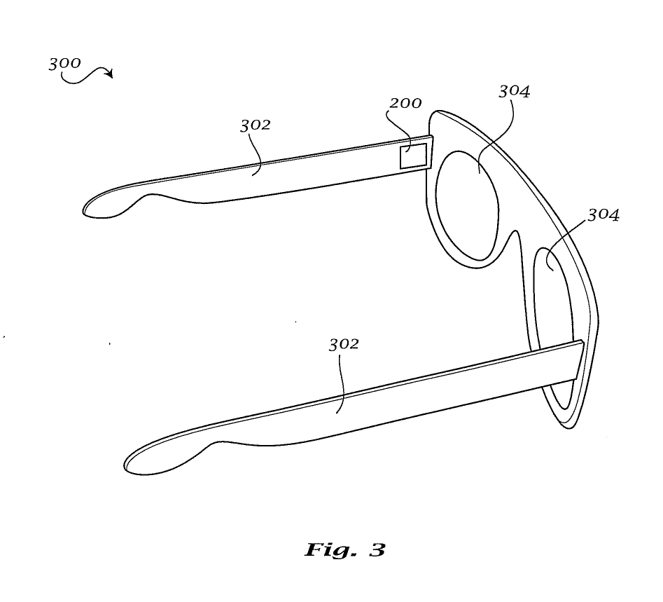

Now referring to FIG. 3, in one exemplary embodiment, chip 200 may be included in any desired eyewear. As depicted in FIG. 3, chip 200 may be included in traditional eyeglasses, but in other exemplary embodiments, chip 200 may be included in goggles, protective eyewear, or any other desired eyewear. In some exemplary embodiments, chip 200 may be manufactured, assembled and subsequently inserted or embedded into any desired eyewear. In other exemplary embodiments, chip 200 may be manufactured, assembled, or some combination thereof, in conjunction with the manufacturing and assembly of any desired eyewear, such as frame 300. Frame 300 may be assembled from multiple parts, including lenses 304, side supports 302, and bridge 204. Each of these parts may be assembled or constructed from multiple pieces. For example, side supports 302, which may be the temples of standard eyewear, may be assembled from two pieces and each piece may contain parts or halves of chip 200 in a manner that chip 200 may be assembled upon the assembly of side supports 302.

Chip 200 may be included or embedded in any desired manner, in any portion or location of any desired eyewear. For example, in one exemplary embodiment, side supports 302 may include an inner and outer portion which may be coupled together in any desired method, such as, but not limited to, screws, a snap fit, or a combination thereof, to form a member which may be substantially hollow. The inner portion of side supports 302 may include a hole or cavity, such that a portion of chip 200, such as second layer 204 or covering 208, may be substantially exposed to the interior of frame 300. Further, the outer portion of side supports 302 may receive or include another piece or portion of chip 200, such has first layer 202. Chip 200 may be coupled to the outer portion of side support 302 in any desired manner, such as with one and one-half millimeter screws inserted through holes 210. Alternatively, in another exemplary embodiment, chip 200 may be incorporated into a molding for any desired eyewear.

In some exemplary embodiments, chip 200 may allow an ophthalmologist or eyewear provider to scan chip 200 in order to determine the eye prescription and preferences of a user. The particular specifications may relate to frame 300, lenses 304 or any combination thereof. For example, the unique identifier 206 may relate to any desired eyewear style preferences, such as, but not limited to, specifications regarding lens size, frame color, and prescription. Any other information, such as medical history, medical prescription, allergy information may also be stored therein. Thus, a user may be provided with adequate or preferred eyewear solutions without producing a prescription or relaying eyewear preferences to a salesperson.

Still referring to FIG. 3, in some exemplary embodiments, chip 200 may interact or function with systems contained within frame 300. For example, in some exemplary embodiments, frame 300 may contain image capturing functionality, such as still and video camera functionality. In this exemplary embodiment, frame 300 may either capture images disposed substantially in front of frame 300, such as something which a user is currently looking at, or alternatively, images disposed substantially behind frame, such as images of a user's eyes. In such exemplary embodiments, chip 200 may associate the images with the particular identifier 206 of the chip 200 installed in the frame 300. Thus, images captured by frames 300 or lenses 304 may be subsequently received by any desired receiver, such that chip 200 may facilitate the transfer of data, images or the identification of eye illness or medical conditions.

In other exemplary embodiments, chip 200 may interact or function with any desired systems contained within frame 300. For example, if frame 300 contains photochromatic or light emitting diode (“LED”) technology allowing for the display or viewing of image or video data, chip 200 may in certain instances, allow a user to adjust the color of the lenses 304 or the frame 300. For example, if a receiver determines that chip 200 is in a certain location, such as in a low-light location, lenses 304 may remain clear. In other exemplary embodiments, users may associate a specific color for frame 300 with a particular identifier 206, such that a provider may provide or program eyewear with any desired color frame.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A pair of eyewear comprising:
an eyewear frame having at least a bridge and temples, a chip embedded in at least one of said temples, said chip comprising:
a first substrate and a second substrate, wherein the first and second substrate are coupled together around the edges of the second substrate and form an interior pocket;
an RFID chip integrally formed within said interior pocket;
a unique identifier; and
a microprocessor

2. The eyewear of claim 1, further comprising a microprocessor.

3. The eyewear of claim 1, further comprising internal memory

4. The eyewear of claim 3, wherein the internal memory ranges from 8-bit to 32-bit.

5. The eyewear of claim 1, wherein at least one of the temples includes an interior cavity with exposure to the interior of the frame.

6. The eyewear of claim 5, further comprising a clear coated material sealing the interior cavity of the temples.

7. The eyewear of claim 1, wherein the eyewear frame is molded around the chip.

8. The eyewear of claim 1, wherein the chip includes positional tracking functionality.

9. The eyewear of claim 8, wherein the positional tracking is accomplished by a GPS system.

10. The eyewear of claim 3, wherein the positional tracking is accomplished by RFID geotagging.

11. The eyewear of claim 1 wherein the unique identifier relates to data stored in an external server.

12. The eyeglasses of claim 11, wherein the data relates to eyewear style preferences.

13. The eyeglasses of claim 1, wherein the chip includes social networking functionality.

14. A system of data retrieval and storage comprising:
a chip, wherein the chip is embedded in a pair of eyewear and has a particular identifier associated with it; and
data, wherein the data may be accessed by the chip.

15. The system of claim 14, wherein the data is contained within the chip.

16. The system of claim 14, wherein the data is contained within an external database.

17. The system of claim 14 wherein said chip comprises:
a first substrate and a second substrate, wherein the first and second substrate are coupled together around the edges of the second substrate and form an interior pocket;
an RFID chip integrally formed within said interior pocket;
a unique identifier; and
a microprocessor.

18. The system of claim 14 wherein the data retrieved includes positional tracking data.

19. The system of claim 14, wherein the data retrieved relates to eyewear style preferences.

20. The system of claim 14, wherein the data retrieved relates to social networking.
